(19) United States
(12) Patent Application Publication
(10) Pub. No.: US 2013/0219966 A1
(43) Pub. Date: Aug. 29, 2013

(54) METHOD OF MANUFACTURING CHEMICALLY STRENGTHENED GLASS PLATE

(71) Applicant: Central Glass Company, Limited, (US)

(72) Inventors: Satoshi HASEGAWA, Mie (JP); Tatsuya TSUZUKI, Mie (JP); Tadashi MURAMOTO, Mie (JP); Naoki MITAMURA, Mie (JP); Yu MATSUDA, Mie (JP)

(73) Assignee: CENTRAL GLASS COMPANY, LIMITED, Yamaguchi (JP)

(21) Appl. No.: 13/795,626

(22) Filed: Mar. 12, 2013

(30) Foreign Application Priority Data
Jan. 10, 2013 (JP) 2013-002747

(51) Int. Cl. C03C 21/00

(52) U.S. Cl. CPC C03C 21/002
USPC 65/30.14

(57) ABSTRACT

[Subject]

An object of the present invention is to provide a method for manufacturing a chemically strengthened glass plate having a high surface compressive stress with high efficiency using a soda-lime glass, the composition of which is not particularly suited for chemical strengthening.

[Solution]

The present invention provides a method of manufacturing a chemically strengthened glass plate by ion-exchanging a glass base plate to replace alkali metal ions A that are the main alkali metal ion component of the glass base plate with alkali metal ions B having a larger ionic radius than the alkali metal ions A at a surface of the glass base plate,
the unexchanged glass base plate made of a soda-lime glass,
the method including:
a first step of contacting the glass base plate with a first salt containing the alkali metal ions A, the first salt containing the alkali metal ions A at a ratio X, as expressed as a molar percentage of total alkali metal ions, of 90 to 100 mol %;
a second step of contacting the glass plate with a second salt containing the alkali metal ions B after the first step, the second salt containing the alkali metal ions A at a ratio Y, as expressed as a molar percentage of the total alkali metal ions, of 0 to 10 mol %; and
a third step of contacting the glass plate with a third salt containing the alkali metal ions B after the second step, the third salt containing the alkali metal ions B at a ratio Z, as expressed as a molar percentage of the total alkali metal ions, of 98 to 100 mol %.

### TECHNICAL FIELD

The present invention relates to a method of manufacturing a chemically strengthened glass plate, specifically a method of manufacturing a chemically strengthened glass plate suited for cover glasses or integrated cover glasses having functions of both a substrate and a cover glass for display arrangements (including display arrangements having functions of an input arrangement) of electric devices (e.g. mobile phones, smartphones, tablet computers).

### BACKGROUND ART

Resin covers are widely used as display protectors for mobile electronic devices such as mobile phones and smart phones. Such resin covers, however, are exceeded by those made of glass in terms of excellence in transmittance, weather resistance, and damage resistance, and additionally, glass improves the aesthetics of displays. Accordingly, there has been an increasing demand for display protectors made of glass in recent years. Furthermore, a trend toward thinner and lighter mobile devices has naturally created a demand for thinner cover glasses. A cover glass is a component that has an exposed surface, and therefore is susceptible to cracking when exposed to an impact (e.g. contact with a hard object, dropping impact). Obviously, the thinner the cover glass, the higher the probability of cracking. Accordingly, a demand for a glass with sufficient mechanical strength is increasingly growing.

A possible strategy to solve the above problem is to improve the strength of cover glasses. The following two methods for strengthening glass plates have been known: thermal strengthening (physical strengthening); and chemical strengthening.

The former method (i.e. thermal strengthening) involves heating a glass plate nearly to its softening point and rapidly cooling the surface thereof with a cool blast or the like. Unfortunately, this thermal strengthening method, when performed on a thin glass plate, is less likely to establish a large temperature differential between the surface and the inside of the glass place, and therefore less likely to provide a compressive stress layer at the glass plate surface. Thus, this method fails to provide desired high strength. Another fatal problem is that processing (e.g. cutting) of a thermally strengthened glass plate is difficult because the glass plate will shatter when a preliminary crack for cutting is formed on the surface. Additionally, as opposed to the above-mentioned demand for thinner cover glasses, the thermal strengthening method fails to provide desired high strength when performed on a thin glass plate because this method is less likely to establish a large temperature differential between the surface and the inside of the glass plate, and therefore less likely to provide a compressive stress layer at the glass plate surface. Accordingly, cover glasses strengthened by the latter method (i.e. chemical strengthening) are generally used instead.

The chemical strengthening method involves contacting a glass plate containing an alkali component, for example, sodium ions with a molten salt containing potassium ions to cause ion exchange between sodium ions in the glass plate and potassium ions in the molten salt, thereby forming a compressive stress layer for improving the mechanical strength at the surface of the glass plate. In the glass place subjected to this method, potassium ions, which have a larger ionic radius than sodium ions, in the molten salt have replaced sodium ions in the glass plate, and thus are incorporated in a surface layer of the glass plate, which is accompanied by a volume expansion of the surface layer. Under the temperature conditions of this method, the glass cannot flow in a viscous manner at a speed high enough to reduce the expansion. Consequently, the expansion remains as residual compressive stress in the surface layer of the glass plate, and improves the strength.

Surface compressive stress and depth of a compressive stress layer can be used as measures of the strength of chemically strengthened glasses.

The term “surface compressive stress” or simply “compressive stress” refers to compressive stress in the outermost layer of a glass plate, which is caused by incorporation of ions having a larger volume into the surface layer of the glass plate by ion exchange. Compressive stress cancels tensile stress that is a factor of breaking glass plates, and thus contributes to higher strength of chemically strengthened glass plates than that of other glass plates. Accordingly, the surface compressive stress can be used as a direct measure for the improvement of the strength of glass plates.

The “depth of a compressive stress layer” or simply “depth of layer” refers to the depth of an area where compressive stress is present, as measured from the outermost surface as a standard. A deeper compressive stress layer corresponds to higher ability to prevent a large microcrack (crack) on the surface of the glass plate from growing, in other words, higher ability to maintain the strength against damage.

In addition to their thin but highly strengthened glass plate structures, another reason why chemically strengthened glass plates are commercially popular is that these glasses can be cut although they are already strengthened. In contrast, processing (e.g. cutting) of a glass plate already strengthened by the thermal strengthening method is difficult because the plate will shatter when a preliminary crack for cutting is formed on the surface.

It is generally known that thermally strengthened glass plates have a compressive stress layer having a depth of about ⅙ of the entire plate thickness at each glass surface. Strong tensile stress occurs in the inside glass region under this deep compressive stress layer to achieve a mechanical balance with the compressive stress in the compressive stress layer. If a preliminary crack for cutting the glass is formed to reach the tensile stress region, the tensile stress automatically propagates the crack to shatter the glass. This is why thermally strengthened glass plates cannot be cut.

In contrast, for chemically strengthened glass plates, their compressive stress layers and surface compressive stresses can be controlled by changing ion exchange conditions, and their compressive stress layers are very thin compared to those of thermally strengthened glass plates. Namely, the compressive stress layers and the surface compressive stresses of the chemically strengthened glasses can be controlled to avoid strong tensile stress that may cause a preliminary crack for cutting formed on the glass plate to automatically propagate and therefore to shatter the glasses. This is why general chemically strengthened glasses can be cut.

One example of methods for chemically strengthening glasses is the method disclosed in Patent Literature 1 which includes: ion-exchanging a portion of first metal ions in a glass with second metal ions in a first salt bath (primary ion exchange stage); and ion-exchanging another portion of the first metal ions in the glass with the second metal ions in a second salt bath (secondary ion exchange stage).

Another example is the method disclosed in Patent Literature 2 which includes: increasing only the amount of main alkali metal ions A, which are the main component of a glass article, in a surface layer of the glass article (primary treatment); and ion exchanging the alkali metal ions A with alkali metal ions B having a larger ionic radius than the alkali metal ions A (secondary treatment).

### CITATION LIST

### Patent Literature

Patent Literature 1: JP-T 2011-529438

Patent Literature 2: JP-B H08-18850

### SUMMARY OP INVENTION

### Technical Problem

The method of Patent Literature 1 is characterized in that the first salt bath containing the second metal ions (potassium ions in EXAMPLES) is diluted with the first metal ions (sodium ions in EXAMPLES), and the second salt bath containing the second metal ions has a lower first metal ion concentration than that of the first salt bath.

In the method of Patent Literature 1, a glass is strengthened to have a compressive stress layer having a desired depth in the primary ion exchange stage. As this ion exchange stage is repeatedly performed using the same salt bath to mass-produce chemically strengthened glasses, the first salt bath becomes diluted with the first metal lens flowing out from glasses. This is accompanied by a gradual decrease of the compressive stress at the glass surface after the primary stage. However, by performing the secondary ion exchange stage using the second salt bath having a lower first metal ion concentration than that of the first salt bath, chemically strengthened glasses having a high surface compressive stress can be produced.

Patent Literature 1 discloses, as an example of glass suited for chemical strengthening, only an alkali aluminosilicate glass (aluminosilicate glass).

In general, soda-lime glass is not suited for chemical strengthening that involves ion exchange in a glass surface layer although it has been used as a material for windowpanes, glass bins, and the like, and is a low-cost glass suited for mass production. On the other hand, aluminosilicate glass is designed to have a higher ion exchange capacity than soda-lime glass by, for example, increasing the amount of Al₂O₃, which improves the ion exchange capacity, and adjusting the ratio between alkali metal oxide components Na₂O and K₂O and/or the ratio between alkaline-earth metal oxide components MgO and CaO, and thus is optimized for chemical strengthening.

Aluminosilicate glass, which has higher ion exchange capacity than soda-lime glass as described above, is able to form a deep compressive stress layer having a depth of 20 μm or more, or a deeper depth of 30 μm or more. A deep compressive stress layer has high strength and high damage resistance, but unfortunately, this means that it does not allow even a preliminary crack for glass cutting processing to be formed thereon. Even if a crack can be formed on the glass, it is impossible to cut the glass along the crack, and if a deeper crack is formed, the glass may shatter. Thus, it is very difficult to cut chemically strengthened aluminosilicate glasses.

Even it the problem of cutting were overcome, aluminosilicate glass requires a higher melting temperature than soda-lime glass because it contains larger amounts of Al₂O₃ and MgO, which elevate the melting temperature, compared to soda-lime glass. In a mass production line, it is produced via a highly viscous molten glass, which leads to poor production efficiency and high costs.

Accordingly, there is a demand for a technique enabling use of soda-lime glass, which is widely used for glass plates, is more suited for mass production than aluminosilicate glass, and therefor is available at low cost, and is already used in various applications, as a glass material.

On the other hand, the method of Patent Literature 2 is characterized by its primary treatment, that is, contacting a glass article with a pure salt of an main alkali metal ion A (sodium ion in EXAMPLES), which is the main component of the glass article. This method increases the amount of the main alkali metal ions A (e.g. sodium ions), which are tube exchanged, in a glass surface layer in the primary treatment, and thereby increases the residual compressive stress that is generated by exchanging the main alkali metal ions A with alkali metal ions B (e.g. potassium ions) in the secondary treatment.

The present inventors studied a way to improve the strength of a soda-lime glass based on Patent Literature 2, and found some points to be improved.

Specifically, when the method of Patent Literature 2 is used to produce chemically strengthened glasses of a soda-lime glass, chemically strengthened glasses produced immediately after the onset of production have a high surface compressive stress, but the surface compressive stress of products gradually decreases as the production processes are repeated. Thus, the present inventors found that it is difficult to continuously produce chemically strengthened glasses having a certain level of surface compressive stress. Namely, the method of Patent Literature 2 has room for improvement in terms of continuous production of chemically strengthened glasses having a high surface compressive stress.

In order to solve the above problems of the conventional techniques, the present invention aims to provide a method for efficiently produce chemically strengthened glass plates having a high surface compressive stress using a soda-lime glass, the composition of which is not particularly suited for chemically strengthening.

### Solution to Problem

As described above, Patent Literature 1 relates to chemical strengthening of an aluminosilicate glass, and does not describe or even suggest chemical strengthening of a soda-lime glass.

The method of Patent Literature 1 is characterized by preventing the salt bath from being diluted with first metal ions (e.g. sodium ions) flowing out from glasses. From Patent Literature 1, a person skilled in the art would not achieve an idea of intentionally increasing the amount of the first metal ions in a glass before ion exchange.

The present inventors unexpectedly found a method that is beyond the technical knowledge of the conventional art, specifically found that continuous production of chemically strengthened glasses having a high surface compressive pressure is enabled by increasing the amount of alkali metal ions A (e.g. sodium ions), which are the main component, in a soda-lime glass, and then ion-exchanging the glass using a salt free of or containing only a smaller amount of the alkali metal ions A, and ion-exchanging the glass using a substantially pure salt of an alkali metal ion B. Thus, the present invention was completed.

Specifically, the present invention provides a method of manufacturing a chemically strengthened glass plate by ion-exchanging a glass base plate to replace alkali metal ions A that are the main alkali metal ion component of the glass base plate with alkali metal ions B having a larger ionic radius than the alkali metal ions A at a surface of the glass bass plate,

the unexchanged glass base plate made of a soda-lime glass,

the method including:

a first step of contacting the glass base plate with a first salt containing the alkali metal ions A, the first salt containing the alkali metal ions A at a ratio X, as expressed as a molar percentage of total alkali metal ions, of 90 to 100 mol %;

a second step of contacting the glass plate with a second salt containing the alkali metal ions B after the first step, the second salt containing the alkali metal ions A at a ratio Y, as expressed as a molar percentage of the total alkali metal ions, of 0 to 10 mol %; and

a third step of contacting the glass plate with a third salt containing the alkali metal ions B after the second step, the third salt containing the alkali metal ions B at a ratio Z, as expressed as a molar percentage of the total alkali metal ions, of 98 to 100 mol %.

The method of manufacturing a chemically strengthened glass plate of the present invention is characterized by using a soda-lime glass. This feature provides an advantage in that unlike methods using glasses that are modified from a soda-lime glass by, for example, using different materials to be suited for chemical strengthening, the method of the present invention can avoid production cost increases that are a result of a change of the materials, reduced production efficiency, and the like.

For example, to increase the amount of aluminum oxide in a composition (e.g. the design of the composition of aluminosilicate glass) is effective for increasing the ion exchange capacity, but is accompanied by not only increased material costs but also remarkable elevation of the melting temperature of the glass, which contributes to remarkably high production costs of the glass. Another effective way to increase the ion exchange capacity is to use MgO as the alkaline-earth metal component in place of a portion of CaO. This, however, also elevates the melting temperature of the glass, and thereby leads to increased production costs.

In the first step of the method of manufacturing a chemically strengthened glass plate of the present invention, a glass base plate is contacted with a first salt containing alkali metal ions A at a ratio X, as expressed as a molar percentage of total alkali metal ions, of 90 to 100 mol %. The first step increases the proportional amount of the alkali metal ions A in a surface layer of the glass plate. This allows the glass plate to finally become a chemically strengthened glass having a high surface compressive stress through the subsequent second and third steps.

In the second step, the glass plate is contacted with a second salt that contains the alkali metal ions B, and also contains the alkali metal ions A at a ratio Y, as expressed as a molar percentage of the total alkali ions, of 0 to 10 mol %, and then, in the third step, the glass plate is contacted with a third salt containing the alkali metal ions B at a ratio Z, as expressed as a molar percentage of the total alkali metal ions, or 98 so 100 mol %.

In the known method disclosed in Patent Literature 2, immediately after the proportional amount of main alkali metal ions A (sodium ions) in a surface layer of a glass plate is increased, the glass plate is contacted with a pure salt of an alkali metal ion B (potassium ion). Disadvantageously, when this method is performed using a single salt bath for the ion exchange to mass produce chemically strengthened glasses, the resulting chemically strengthened glasses have a widely different surface compressive stress from one another. This is presumably because the salt bath of the pure salt of an alkali metal ion B is diluted with the main alkali metal ions A flowing out from the glasses, and thereby creates a trend toward decreased surface compressive stresses of chemically strengthened glasses. Therefore, in order to continuously produce chemically strengthened glasses having a certain level of surface compressive stress, the salt is frequently replaced with another pure salt after being diluted.

Likewise, in the method of manufacturing a chemically strengthened glass plate of the present invention, the second salt bath is diluted with the alkali metal ions A flowing out from glass plates. However, the proportional amount (ratio Y) of the alkali metal ions A in the second salt bath is limited within the range of 0 to 10 mol %. Of course, as the proportional amount or the alkali metal ions A in the second salt bath becomes large, in other words, the proportional amount of the alkali metal ions B becomes small, the surface compressive stress measured after the second step becomes low. However, chemically strengthened glasses having a high surface compressive stress can be finally produced by using the third salt bath containing the alkali metal ions B at a high level in the third step, as long as the ratio Y is in the range of 0 to 10 mol %.

In the method of manufacturing a chemically strengthened glass plate of the present invention, a major portion of the alkali metal ions A is exchanged in the second step, and fewer alkali metal ions A flow out from glasses in the third step. Accordingly, it is possible to prevent the third salt bath used in third step from being diluted. This is why the third salt bath can maintain its high proportional amount (ratio Z) of the alkali metal ions B.

As described above, the method of manufacturing a chemically strengthened glass plate of the present invention allows for continuous production of chemically strengthened glasses having a high surface compressive stress without the need to frequently replace the salt baths used for ion exchange, as opposed to the method of Patent Literature 2.

Thus, the method of manufacturing a chemically strengthened glass plate of the present invention allows for continuous production of chemically strengthened glasses having a high surface compressive stress using a soda-lime glass by performing all the first to third steps.

In the method of manufacturing a chemically strengthened glass plate of the present invention, it is preferable that the soda-lime glass is substantially composed of 65 to 75% SiO₂, 5 to 20% Na₂O+K₂O, 2 to 15% CaO, 0 to 10% MgO, and 0 to 5% Al₂O₃ on a mass basis.

Preferably, a chemically strengthened glass plate produced by the method of manufacturing a chemically strengthened glass plate of the present invention has a thickness of 0.03 to 3 mm.

In general, the thinner the chemically strengthened glass plate, the higher the tensile stress occurs in the inside to achieve a balance with accumulated compressive stress in the compressive stress layer. In contrast, chemically strengthened glass plates produced by the manufacturing method of the present invention are thin yet are easy to cut and have strength.

In the case where such chemically strengthened glass plates produced by the manufacturing method of the present invention are intended to be used for cover glasses for display devices, they are preferably as thin as possible to reduce the weight of final products (e.g. mobile products) and ensure the space for batteries or other components in device products. Unfortunately, however, too thin a glass plate may generate a large stress when it warps. On the other hand, too thick a glass plate increases the weight of final device products and degrades the visibility of display devices.

Preferably, a chemically strengthened glass plate produced by the method of manufacturing a chemically strengthened glass plate of the present invention has a surface compressive stress of 600 to 900 MPa.

A surface compressive stress of 600 to 900 MPa is a sufficient level of strength for chemically strengthened glass plates.

Preferably, a chemically strengthened glass plate produced by the method of manufacturing a chemically strengthened glass plate of the present invention has a compressive stress layer having a depth of 5 to 25 μm at a surface thereof.

A glass having a compressive stress layer having a depth of less than 5 μm cannot withstand commercial use because microcracks may be formed in use and such microcracks reduce the strength of the glass. On the other hand, a glass having a compressive stress layer having a depth of more than 25 μm may be difficult to cut by scribing.

In the method of manufacturing a chemically strengthened glass plate of the present invention, the alkali metal ions A are preferably sodium ions, and the alkali metal ions B are preferably potassium ions.

### Advantageous Effects of Invention

The method of manufacturing a chemically strengthened glass plate of the present invention allows for efficient production of chemically strengthened glass plates having a high surface compressive stress using a soda-lime glass.

### BRIEF DESCRIPTION OF DRAWINGS

FIG. 1 is a graph of the surface compressive stresses measured after the second and third steps.

### DESCRIPTION OF EMBODIMENTS

The following description is offered to specifically illustrate an embodiment of the present invention. It should be noted that the present invention is not limited only to this embodiment, and the embodiment can be appropriately altered within the scope of the present invention.

A method of manufacturing a chemically strengthened glass plate according to one embodiment of the present invention involves ion-exchanging a glass base plate to replace alkali metal ions A that are the main alkali metal ion component of the glass base plate with alkali metal ions B having a larger ionic radius than the alkali metal ions A at a surface of the glass base plate.

In the case where the alkali metal ions A are, for example, sodium ions (Na⁺ ions), the alkali metal ions B may be at least one species of ions selected from potassium ion (K⁺ ion), rubidium ion (Rb⁺ ion), and cesium ion (Cs⁺ ion). In the case where the alkali metal ions A are sodium ions, the alkali metal ions B are preferably potassium ions.

In the method of manufacturing a chemically strengthened glass plate according to the embodiment of the present invention, the unexchanged glass base plate is made of a soda-lime glass. Preferably, the soda-lime glass is substantially composed of 65 to 75% SiO₂, 5 to 20% Na₂O+K₂O, 2 to 15% CaO, 0 to 10% MgO, and 0 to 5% Al₂O₃ on a mass basis.

The expression “5 to 20% Na₂O+K₂O” herein means that the proportional amount of Na₂O and K₂O in total in the glass is 5 to 20% by mass.

SiO₂ is a major constituent of glass. If the proportional amount of SiO₂, is less than 65%, the glass has reduced strength and poor chemical resistance. On the other hand, if the proportional amount of SiO₂ is more than 75%, the glass becomes a highly viscous melt at high temperatures. Such a glass is difficult to form into a shape. Accordingly, the proportional amount should be in the range of 65 to 75%, and preferably 68 to 73%.

Na₂O is an essential component that is indispensable for the chemical strengthening treatment. If the proportional amount of Na₂O is less than 5%, sufficient ions are not exchanged, namely, the chemically strengthening treatment does not improve the strength very much. On the other hand, if the proportional amount is more than 20%, the glass may have poor chemical resistance and poor weather resistance. Accordingly, the proportional amount should be in the range of 5 to 20%, preferably 5 to 18%, and more preferably 7 to 16%.

K₂O is not an essential component, but acts as a flux for the glass together with Na₂O upon melting the glass, and acts also as an adjunct component for accelerating ion exchange when added in a small amount. However, when excessive K₂O is used, K₂O produces a mixed alkali effect with Na₂O to inhibit movement of Na⁺ ions. As a result, the ions are less likely to be exchanged. If the proportional amount of K₂O is more than 5%, the strength is less likely to be improved by ion exchange. Accordingly, the proportional amount is preferably not more than 5%. In the case where the alkali metal ions A and the alkali metal ions B are sodium ions and potassium ions, respectively, K₂O is preferably present in the glass in an amount of 0.1 to 4% because the first step requires potassium ions to be exchanged with sodium ions.

The proportional amount of Na₂O+K₂O is 5 to 20%, preferably 7 to 18%, and more preferably 10 to 17%.

CaO improves the chemical resistance of the glass, and additionally reduces the viscosity of the glass in the molten state. For the purpose of improving the mass productivity of the glass, CaO is preferably present in an amount of not less than 2%. However, if the proportional amount exceeds 15%, it acts to inhibit movement of Na⁺ ions. Accordingly, the proportional amount should be in the range of 2 to 15%, preferably 4 to 13%, and mere preferably 5 to 11%.

MgO is also not an essential component, but is preferably used in place of a portion of CaO because if is less likely to inhibit movement of Na⁺ ions than CaO. MgO, however, is not as effective as CaO in reducing the viscosity of the glass in the molten state. When MgO is used in an amount of more than 10%, it allows the glass to become highly viscous, which is a contributing factor to poor mass productivity of the glass. Accordingly, the proportional amount should be in the range of 0 to 10%, preferably 0 to 8%, and more preferably 1 to 6%.

Al₂O₃ is not an essential component, but improves the strength and its ion exchange capacity. If the proportional amount or Al₂O₃ is more than 5% on a mass basis, the glass becomes a highly viscous melt at high temperatures, and additionally is likely to be devitrified. Such a glass melt is difficult to form into a shape. Moreover, the ion exchange capacity is increased too much, and therefore a deep compressive stress may be formed. As a result, the chemical strengthening may make the glass difficult to cut. Accordingly, the proportional amount should be in the range of 0 to 5%, preferably 1 to 4%, and more preferably 1 to 3% (not including 3).

Regarding a chemically strengthened glass plate according to one embodiment of the present invention, the unexchanged base glass is preferably substantially composed of the above components, but may further contains small amounts, specifically up to 1% in total, of other components such as Fe₂O₃, TiO₂, CeO₂, and SO₃.

The unexchanged base glass preferably has a strain point of 450 to 550 ° C., and more preferably 480 to 530° C. If the glass has a strain point of lower than 450° C., it does not have heat resistance high enough to withstand the chemical strengthening. On the other hand, if the strain point is higher than 550° C., the glass has too high a melting temperature, which means that such glass plates cannot be produced efficiently and icrease costs.

The unexchanged base glass is preferably one formed by common glass forming processes such as a float process, a roll-out process, and a down draw process. Among these, one formed by a float process is preferable.

The surface of the unexchanged base glass prepared by such a forming process described above may remain as is, or may be roughened by hydrofluoric acid etching or the like to have functional properties such as antiglare properties.

The scope of the unexchanged base glass is not particularly limited, and is preferably a plate shape. In the case where the glass has a plate shape, it may be a flat plate or a warped plate, and various shapes are included within the scope of the present invention. Shapes such as rectangular shapes and disc shapes are included within the definition of the flat plate in the present invention, and rectangular shapes are preferable among others.

The method of manufacturing a chemically strengthened glass plate according to the embodiment of the present invention includes the first step of contacting the glass base plate with a first salt containing the alkali metal ions A at a ratio X, as expressed as a molar percentage of total alkali metal ions, of 90 to 100 mol %.

The phrase “contacting a glass plate with a salt” used herein means to contact the glass plate with a salt bath or submerge the glass plate in a salt bath. Thus, the term “contact” used herein is intended to include “submerge” as well.

The contact with a salt can be accomplished by, for example, directly applying the salt in a paste form to the glass plate, spraying the salt in an aqueous solution form, submerging the glass plate into a molten salt heated to its melting point or higher. Among these, submerging into a molten salt is preferable.

Specific examples of the alkali metal ions A are described above, and in particular, the alkali metal ions A are preferably sodium ions.

The salt may be one of or a mixture of two or more of nitrates, sulfates, carbonates, hydroxide salts, and phosphates. Among these, nitrates are preferable.

the ratio X (mol %) of the alkali metal ions A in the first salt is 90 to 100 mol % as expressed as a molar percentage of total alkali metal ions, and is preferably 95 to 100 mol %, and more preferably 98 to 100 mol %. In particular, it is preferable that the ratio X of the first salt is 100 mol %, in other words, the first salt is substantially free of other alkali metal ions, and the alkali metal ions A (e.g. sodium ions) are the only cation component in the first salt.

If the ratio X of the first salt is too small, the first salt is less likely to exhibit an effect of increasing the amount of the alkali metal ions A in the surface layer of the glass plate, and therefore a chemically strengthened glass plate having a desired surface compressive stress cannot be produced even if the second and third steps are performed.

The salt temperature (the temperature of the first salt) in the first step is preferably 375 to 520° C. The lower limit of the first salt temperature is more preferably 385° C., and further more preferably 400° C. The upper limit of the first salt temperature is more preferably 510° C., and further more preferably 500° C.

Too high a first salt temperature is likely to make the glass surface cloudy. On the other hand, at too low a first salt temperature, an effect of improving the glass surface may not be obtained sufficiently in the first step.

The time period of the contact of the glass plate with the first salt is the first step is preferably 0.5 to 10 hours, and more preferably 1 to 7 hours. Too long a contact of the glass plate with the first salt elongates the time period required for the production of a chemically strengthened glass. On the other hand, too short a contact of the glass plate with the first salt may not produce a sufficient effect of improving the glass surface layer in the first step.

The method of manufacturing a chemically strengthened glass plate according to the embodiment of the present invention includes the second step of contacting the glass plate with a second salt containing the alkali metal ions B after the first step. The second salt contains the alkali metal ions A at a ratio Y, as expressed as a molar percentage of the total alkali metal ions, of 0 to 10 mol %.

Specific examples of the alkali metal ions A and the alkali metal ions B are those described above. The alkali metal ions A are preferably sodium ions, and the alkali metal ions B are preferably potassium ions.

The salt may be one of or a mixture of two or more of nitrates, sulfates, carbonates, hydroxide salts, and phosphates. Among these, nitrates are preferable. Compared to use of a nitrate alone, use of a mixture of a nitrate and a hydroxide salt increases the compressive stress generated in the second step. It should be noted that if a glass plate subjected only to the second step is stored in the air, the surface thereof is likely to become cloudy. However, by performing the later-described third step after the second step, if becomes possible to prevent the glass surface from becoming cloudy and provide a high surface stress. Such a hydroxide salt is preferably mixed with a nitrate in an amount of 0 to 1500 ppm, more preferably 0 to 1000 ppm relative to 100 mol % of the nitrate.

The ratio Y (mol %) of the alkali metal ions A in the second salt is 0 to 10 mol % as expressed as a molar percentage of the total alkali metal ions, and is preferably 0 to 5 mol %, and more preferably 0 to 1 mol %. In particular, it is preferable that the ratio Y of the second salt is preferably 0 mol %, and more preferable that the second salt is substantially free of the alkali metal ions A, and the alkali metal ions B (e.g. potassium ions) are the only cation component in the second salt.

If the ratio Y of the second salt is more than 10 mol %, sufficient alkali metal ions B may not be introduced into the glass surface layer in the second step, and therefore a chemically strengthened glass plate having a desired surface compressive stress cannot be produced even if the subsequent third step is performed.

The second salt is preferably a fresh pure salt of the alkali metal ion B, but may be a used salt diluted with the alkali metal ions A.

In the second step, it is preferable that the treatment temperature (the temperature of the second salt) is controlled according to the ratio Y of the second salt such that a compressive stress layer having a depth of 3 to 25 μm (more preferably 5 to 20 μm, further more preferably 5 to 18 μm) is formed through the second step.

Too high a treatment temperature (temperature of the second salt) in the second step is likely to make the glass surface cloudy. In addition, a deeper compressive stress layer may be formed, which may affect the ease of cutting the resulting glass. On the other hand, at too low a second salt temperature, ion exchange in the second step may not be accelerated, and a compressive stress layer having a desired depth may not be formed.

Accordingly, the second salt temperature is preferably 360 to 500° C. The lower limit of the second salt temperature is more preferably 390° C., and further more preferably 400° C., The upper limit of the second salt temperature is more preferably 490° C., and further more preferably 480° C.

The time period of the contact of the glass plate with the second salt in the second step is preferably 1 to 6 hours, and more preferably 1 to 4 hours. Too long a contact of the glass plate with the second salt tends to relax the compressive stress once generated in the second step, and additionally tends to provide a deeper compressive stress layer. This affects the ease of cutting the resulting glass. On the other hand, too short a contact of the glass plate with the second salt may not accelerate ion exchange in the second step, and thereby may not provide a compressive stress layer having a desired depth.

The method of manufacturing a chemically strengthened glass plate according to the embodiment of the present invention includes the third step of contacting the glass plate with a third salt containing the alkali metal ions B after the second step. The third salt contains the alkali metal ions B at a ratio Z, as expressed as a molar percentage of the total alkali metal ions, of 98 to 100 mol %.

Specific examples of the alkali metal ions B are those described above, and the alkali metal ions B are preferably potassium ions.

The salt may be one of or a mixture of two or more of nitrates, sulfates, carbonates, hydroxide salts, and phosphates. Among these, nitrates are preferable.

The ratio Z (mol %) of she alkali metal ions B in the third salt is 98 to 100 mol % as expressed as a molar percentage of the total alkali metal ions, and is preferably 99 to 100 mol %, and more preferably 99.3 to 100 mol %. In particular, it is preferable that the ratio Z in the third salt is 100 mol %, in other words, the third salt is substantially free of other alkali metal ions, and the alkali metal ions B (e.g. potassium ions) are the only cation component in the third salt.

If the ratio Z of the third salt is too small, sufficient alkali metal ions B may not be introduced into the glass surface layer in the third step, and a chemically strengthened glass plate having a desired surface compressive stress cannot be produced.

The third salt is preferably a fresh pure salt of the alkali metal ion B, but may be a used salt diluted with the alkali metal ions A or the like.

In the third step, it is preferable that the treatment temperature (the temperature of the third salt) is controlled according to the ratio Z of the third salt such that a compressive stress layer hawing a depth of 5 to 25 μm (more preferably 7 to 20 μm, further more preferably 8 to 18 μm) is formed through the third step.

Too high a treatment temperature (temperature of the third salt) in the third step may relax the compressive stress generated in the second step. In addition, a deeper compressive stress layer may be formed, which may affect the easiness of cutting the resulting glass. On the other hand, at too low a third salt temperature, ion exchange in the third step may not be accelerated. Consequently, a high surface compressive stress may not be generated in the third step, and additionally, a compressive stress layer having a desired depth may not be formed.

Accordingly, the third salt temperature is preferably 380 to 500° C. The lower limit of the third salt temperature is more preferably 390° C., and further more preferably 400° C. The upper limit of the third salt temperature is more preferably 480° C., and further more preferably 470° C.

The time period of the contact of the glass plate with the third salt in the third step is preferably 0.5 to 4 hours, and more preferably 0.5 to 3 hours. In the third step, it is preferable to reduce the relaxation of the stress generated by the ion exchange steps to a minimum. However, a longer contact of the glass plate with the salt increases the relaxation of the stress. Additionally, a longer contact tends to provide a deeper compressive stress layer in the third step. This also affects the ease of cutting the resulting glass. On the other hand, too short a contact of the glass plate with the third salt fails to allow the alkali metal ions A and the alkali metal ions B to be exchanged sufficiently, and therefore a desired level of compressive stress may not be generated.

All of the treatment temperature and the contact time in the first step, the treatment temperature and the contact time in the second step, and the treatment temperature and the contact time in the third step described above are associated with the ion exchange amount (which is defined as a value calculated by dividing the absolute value of the mass difference of the glass plate before and after the chemical strengthening by the surface area of the glass plate). Namely, the treatment temperatures and the contact times are not limited to the above ranges, and may be varied without any limitation, provided that substantially equivalent ion exchange amounts are achieved in the respective steps.

Although the first, second, and third salts are each a pure salt of the alkali metal ion A and/or the alkali metal ion B in the above description, this embodiment does not preclude the presence of stable metal oxides, impurities, and other salts that do not react with the salts, provided that they do not impair the purpose of the present invention. For example, the first, second, and third salts may contain Ag ions or Cu ions.

The upper limit of the thickness of a chemically strengthened glass plate produced by the manufacturing method according to the embodiment of the present invention is not particularly limited, but is preferably 3 mm, more preferably 2.8 mm, and further more preferably 2.5 m. The lower limit of the thickness of a chemically strengthened glass plate produced by the manufacturing method according to the embodiment of the present invention is also not particularly limited, but is preferably 0.03 mm, more preferably 0.1 mm, and further preferably 0.3 mm.

The lower limit of the surface compressive stress at the surface of a chemically strengthened glass plate produced by the manufacturing method according to the embodiment of the present invention is preferably 600 MPa, and may be 620 MPa or 650 MPa. A higher surface compressive stress is preferable, and the upper limit may be 900 MPa, 850 MPa, 800 MPa, or 750 MPa.

A chemically strengthened glass plate produced by the manufacturing method according to the embodiment of the present invention preferably has a compressive stress layer having a thickness of 5 to 25 μm at the surface in terms of both damage resistance and ease of cutting. The depth of the compressive stress layer is more preferably 7 to 20 μm, and further more preferably 8 to 18 μm.

The surface compressive stress generated by ion exchange and the depth of the compressive stress layer formed by ion exchange herein are both measured by photoelasticity with a surface stress meter utilizing optical waveguide effects. It should be noted that the measurement with the surface stress meter requires the refraction index and photoelasticity constant according to the glass composition of each unexchanged base glass.

The chemical strengthened glass preferably has a Vickers hardness of 5.0 to 6.0 GPa, more preferably 5.2 to 6.0 GPa, and further more preferably 5.2 to 5.8 GPa. Glasses having a Vickers hardness of less than 5.0 GPa have poor damage resistance, and therefore cannot withstand commercial use. On the other hand, glasses having a Vickers hardness of more than 6.0 GPa are difficult to cut, and thus affect the yield of a cutting process.

A chemically strengthened glass plate produced by the manufacturing method according to the embodiment of the present invention is preferably used for cover glasses for display devices.

The term “cover glasses for display devices” herein is not limited to only those used alone, and is intended to also include, for example, cover glasses that are used as touch sensor substrates to exhibit functions of a cover and a substrate by themselves (e.g. cover glasses called “One Glass Solution” or “integrated cover glasses”).

Such cover glasses for display devices can be produced by cutting a chemically strengthened glass plate produced by the manufacturing method according to the embodiment of the present invention.

Such a chemically strengthened glass plate is a glass plate larger than desired cover glasses, and its entire main surface and all the side faces are chemically strengthened before the cutting process. This chemically strengthened glass plate can be cut into a plurality of cover glasses by the cutting process. Thus, a plurality of cover glasses can be efficiently produced at the same time from a single large glass plate. The cover glasses obtained by cutting a glass plate may have faces with a compressive stress layer formed thereon and faces without a compressive stress layer among the side faces.

The side faces of the cover glasses are preferably faces formed by physical processing (not only cutting or braking, but also chamfering) such as laser scribing, mechanical scribing, and brush polishing, or chemical processing (chemical cutting) using a hydrofluoric acid solution.

The main surface of the cover glasses for display devices may be provided with anti-fingerprint properties, anti-glare properties, or desired functions by surface coating with a chemical, microprocessing, attaching a film to the surface, or the like. Alternatively, on the main surface, an indium tin oxide (ITO) membrane and then a touch sensor may be formed, or printing may be performed according to the color of the display devices. The main surface may be partially subjected to a processing for making holes or the like. The shape and size of these cover glasses may not be limited to simple rectangular shapes, and various shapes according to the designed shape of the display devices are acceptable such as processed rectangular shapes with round corners.

### EXAMPLES

The following examples are offered to more specifically illustrate the embodiment of the present invention. It should be noted that the present invention is not limited only to these examples.

### Example 1

A glass plate not subjected to ion exchange (chemical strengthening), specifically, a 1.1-mm thick soda-lime glass (SiO₂: 71.3%, Na₂O: 13.0%, K₂O: 0.85%, CaO: 9.01, MgO: 3.6%, Al₂O₃: 2.0%, Fe₂O₃: 0.15%, SO₃: 0.1% (on a mass basis)) produced by a float process was prepared, and about 80-mm diameter disc substrates (hereinafter, referred to as glass base plates) were prepared therefrom.

In the first step, a glass base plate prepared above was submerged in a molten salt bath substantially composed of 100 mol % sodium nitrate (NaNO₃) (first salt, ratio X: 100 mol %) at a constant temperature of 475° C. for two hours.

Subsequently, the glass base plate was taken out from the bath, and its surface was washed and dried.

The glass base plate was measured for the composition with X-ray fluorescence before and after the first step. The results revealed that the proportional amount of sodium in a surface layer after the first step was increased by about 1% by mass from the amount of sodium in the surface layer before the first step.

Subsequently, in the second step, the dried glass base plate was submerged into a molten salt bath substantially composed of 100 mol % potassium nitrate (KNO₃) (second salt, ratio Y: 0 mol %) at a constant temperature of 443° C. for 2.5 hours. In this manner, a glass sample was obtained.

The glass sample was then taken out from the bath, and the surface of the glass sample was washed and dried.

After the second step, the glass sample was measured for the surface compressive stress and the depth of the compressive stress layer formed at the glass surface with a surface stress meter (available from Toshiba Glass Co., Ltd. (currently available from Orihara Industrial Co., Ltd), FSM-60V). The refraction index and photoelasticity constant of the glass composition of the soda-lime glass used for the measurement with the surface stress meter were 1.52 and 26.8 ((nm/cm)/MPa), respectively. The used light source was a sodium lamp.

The results of the measurement revealed that the surface compressive stress and the depth of the compressive stress layer were 721 MPa and 9 μm, respectively.

A glass base plate that was not subjected to the first step but subjected to the second step under the same conditions were also measured for the surface compressive stress and the depth of the compressive stress layer formed at the glass surface. The results of the measurement revealed that the surface compressive stress and the depth of the compressive stress layer were 686 MPa and 9 μm, respectively.

In the third step, the dried glass sample was submerged into a molten salt bath substantially composes of 100 mol % potassium nitrate (third salt, ratio Z: 100 mol %) at a constant temperature of 443° C. for one hour.

The glass sample was then taken out from the bath, and the surface of the glass sample was washed and dried.

Through these steps, a chemically strengthened glass plate of Example 1 was prepared.

The glass sample after the third step (the chemically strengthened glass plate of Example 1) was measured for the surface compressive stress and the depth of the compressive stress layer in the same manner as described above. The results of the measurement revealed that the surface compressive stress and the depth of the compressive stress layer were 702 MPa and 12 μm, respectively.

### Example 2

A mixture molten salt containing 99 mol % potassium nitrate and 1 mol % sodium nitrate (ratio Y: 1 mol %) was prepared as the second salt used in the second step.

A chemically strengthened glass plate was produced in the same manner as in Example 1, except that the above-mentioned second salt was used in the second step.

The surface compressive stress and the depth of the compressive stress layer of the glass sample after the second step were 646 MPa and 10 μm, respectively. The surface compressive stress and the depth of the compressive stress layer of the glass sample after the third step (the chemically strengthened glass plate of Example 2) were 700 MPa and 12 μm, respectively.

### Example 3

A mixture molten salt containing 97 mol % potassium nitrate and 3 mol % sodium nitrate (ratio Y: 3 mol %) was prepared as the second salt for the second step.

A chemically strengthened glass plate was produced in the same manner as in Example 1, except that the above-mentioned second salt was used in the second step.

The surface compressive stress and the depth of the compressive stress layer of the glass sample after the second step were 538 MPa and 10 μm, respectively. The surface compressive stress and the depth of the compressive stress layer of the glass sample after the third step (the chemically strengthened glass plate of Example 3) were 716 MPa and 12 μm, respectively.

### Example 4

A mixture molten salt containing 95 mol % potassium nitrate and 5 mol % sodium nitrate (ratio Y: 5 mol %) was prepared as the second salt for the second step.

A chemically strengthened glass plate was produced in the same manner as in Example 1, except that the above-mentioned second salt was used in the second step.

The surface compressive stress and the depth of the compressive stress layer of the glass sample after the second step were 520 MP a and 8 μm, respectively. The surface compressive stress and the depth of the compressive stress layer of the glass sample after the third step (the chemically strengthened glass plate of Example 4) were 752 MPa and 11 μm, respectively.

### Example 5

A mixture molten salt containing 90 mol % potassium nitrate and 10 mol % sodium nitrate (ratio Y: 10 mol %) was prepared as the second salt for the second step.

A chemically strengthened glass plate was produced in the same manner as in Example 1, except that the above-mentioned second salt was used in the second step.

The surface compressive stress and the depth of the compressive stress layer of the glass sample after the second step were 435 MPa and 8 μm, respectively. The surface compressive stress and the depth of the compressive stress layer of the glass sample after the third step (the chemically strengthened glass plate of Example 5) were 744 MPa and 10 μm, respectively.

### Example 6

As the second salt for the second step, a salt was prepared by adding 1000 ppm of potassium hydroxide to a molten salt bath substantially composed of 100 mol % potassium nitrate.

A chemically strengthened glass plate was produced in the same manner as in Example 1, except that the above-mentioned second salt was used in the second step.

A glass sample subjected to up to the second step was stored in the air for several days, and observed to have a visually cloudy surface, while the glass sample, which was further subjected to the third step, did not become cloudy even after a longer period of storage.

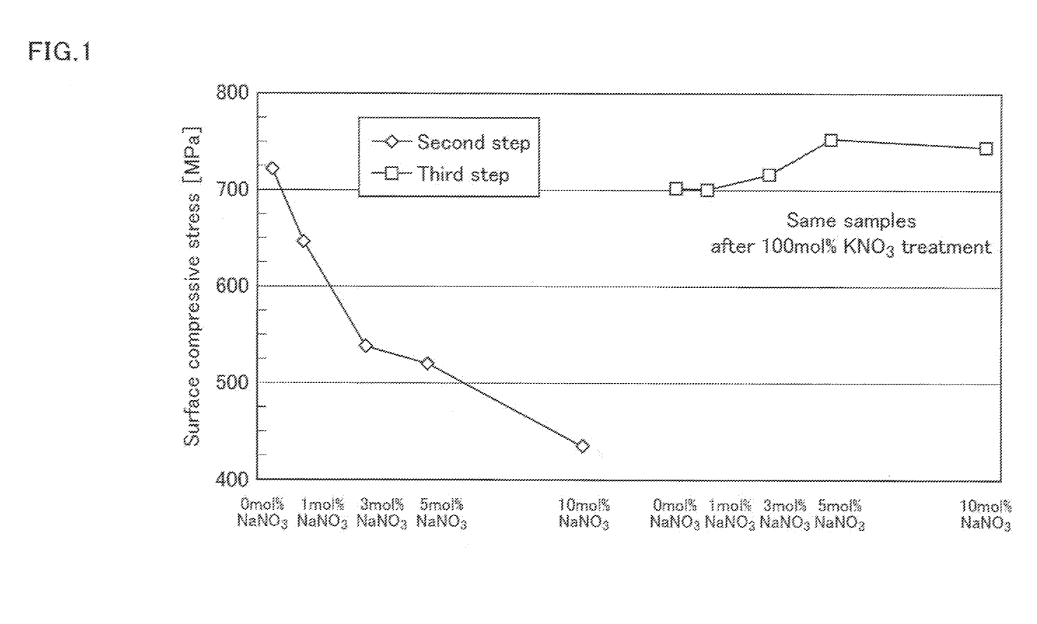

Table 1 shows the ratios X, Y, and Z, the surface compressive stress and the depth of the compressive stress layer after the second step, and the surface compressive stress and the depth of the compressive stress layer after the third step of all the chemically strengthened glass plates of Examples 1 to 5. FIG. 1 is a graph of the surface compressive stresses measured after the second and third steps.

TABLE 1

| | | Second step | | | Third step | | |
|---|---|---|---|---|---|---|---|
| | | | Surface | Depth of | | Surface | Depth of |
| | First step | | compressive | compressive | | compressive | compressive |
| | Ratio X | Ratio Y | stress | stress layer | Ratio Z | stress | stress layer |
| | (mol %) | (mol %) | (MPa) | (μm) | (mol %) | (MPa) | (μm) |
| Example 1 | 100 | 0 | 721 | 9 | 100 | 702 | 12 |
| Example 2 | 100 | 1 | 646 | 10 | 100 | 700 | 12 |
| Example 3 | 100 | 3 | 538 | 10 | 100 | 718 | 12 |
| Example 4 | 100 | 5 | 520 | 8 | 100 | 752 | 11 |
| Example 5 | 100 | 10 | 435 | 8 | 100 | 744 | 10 |

As apparent from Table 1 and FIG. 1, the surface compressive stress after the second step gradually decreases from 721 MPa to 435 MPa with the increase of the ratio Y from 0 to 10 mol %. The second salts used in Examples 1 to 5 can be considered to represent the states of a potassium nitrate salt bath diluted wish sodium ions flowing out from glasses in the process of mass production of chemically strengthened glasses. The results revealed that when a pure salt (ratio Y=0 mol %) is used as in Example 1, even one step of ion exchange provides a surface compressive stress as high as 700 MPa or even higher. Unfortunately, it is assumed that when a single salt bath is repeatedly used for ion exchange in the process of production of chemically strengthened glass plates, the surface compressive stress of products decreases as seen in Examples 2 to 5.

However, the surface compressive stress of all the samples could be improved to 700 MPa or higher by performing the third step using a third salt (ratio Z: 100 mol %). Accordingly, even when ion exchange is performed using the second salt having a ratio Y of 0 to 10 mol %, a surface compressive stress equivalent to that provided by performing a single ion exchange step using a pure salt can be achieved by further performing ion exchange using the third salt.

These results revealed that the method of manufacturing a chemically strengthened glass plate of the present invention allows for continuous production of chemically strengthened glass plates having a high surface compressive stress.

1. A method of manufacturing a chemically strengthened glass plate by ion-exchanging a glass base plate to replace alkali metal ions A that are the main alkali metal ion component of the glass base plate with alkali metal ions B having a larger ionic radius than the alkali metal ions A at a surface of the glass base plate,
the unexchanged glass base plate made of a soda-lime glass,
the method comprising:
a first step of contacting the glass base plate with a first salt comprising the alkali metal ions A, the first salt comprising the alkali metal ions A at a ratio X, as expressed as a molar percentage of total alkali metal ions, of 90 to 100 mol %;
a second step of contacting the glass plate with a second salt comprising the alkali metal ions B after the first step, the second salt comprising the alkali metal ions A at a ratio Y, as expressed as a molar percentage of the total alkali metal ions, of 0 to 10 mol %; and
a third step of contacting the glass plate with a third salt comprising the alkali metal ions B after the second step, the third salt comprising the alkali metal ions B at a ratio Z, as expressed as a molar percentage of the total alkali metal ions, of 98 to 100 mol %.

2. The method of manufacturing a chemically strengthened glass plate according to claim 1,
wherein the soda-lime glass is substantially composed of 65 to 75% SiO₂, 5 to 20% Na₂O+K₂O, 2 to 15% CaO, 0 to 10% MgO, and 0 to 5% Al₂O₃ on a mass basis.

3. The method of manufacturing a chemically strengthened glass plate according to claim 1,
wherein the chemically strengthened glass has a thickness of 0.03 to 3 mm.

4. The method of manufacturing a chemically strengthened glass plate according to claim 1,
wherein the chemically strengthened glass has a surface compressive stress of 600 to 900 MPa.

5. The method of manufacturing a chemically strengthened glass plate according to claim 1,
wherein the chemically strengthened glass has a compressive stress layer having a depth of 5 to 25 μm at a surface thereof.

6. The method of manufacturing a chemically strengthened glass plate according to claim 1,
wherein the alkali metal ions A are sodium ions, and
the alkali metal ions B are potassium ions.
